(19) United States
(12) Patent Application Publication
(10) Pub. No.: US 2003/0182398 A1
(43) Pub. Date: Sep. 25, 2003

(54) Method of establishing a logical association between connections

(76) Inventors: Keven P. Morlang, Fair Oaks, CA (US); Rajeev Grover, Rocklin, CA (US)

Correspondence Address: HEWLETT-PACKARD COMPANY, Intellectual Property Administration, P.O. Box 272400, Fort Collins, CO, 80527-2400, US

(21) Appl. No.: 10/077,465

(22) Filed: Feb. 14, 2002

(51) Int. Cl. G06F 15/16

(52) U.S. Cl. 709/219

(57) ABSTRACT

A method of establishing a logical association between connections. A datum is generated at a first node in response to a request from a second node. The datum is sent to the second node via a first connection. An application program is also sent to the second node. The application program is for the second node to interface with the first node to establish the second connection and to assist in associating the first connection with the second connection. A command is received by the first node from the second node via a second connection. The command includes the datum. A logical association is then established between the first connection and the second connection in response to receiving the command.

### TECHNICAL FIELD

The present invention relates to the field of interconnected computers. Specifically, the present invention relates to a method for logically associating connections between nodes.

### BACKGROUND ART

The proliferation of the Internet has provided computer users with a means to interconnect with other computers and hence avail themselves to a wide variety of services and information heretofore unavailable. However, a conventional connection made by, for example, a web browser uses a connectionless protocol. While this is suitable for many applications, a connectionless protocol does not work well for some applications.

For example, a client may wish to establish a console session with a server. A connectionless protocol is not suitable for this because the console traffic is two-way and continuous. In this case, a connection oriented session is preferred. However, it may be difficult for the client to establish a connection oriented session for the following reasons.

One conventional method of establishing such a session is for the client to first establish a connection to a server via a connectionless protocol. For example the client contacts the server via a web browser. The server will then send back information, which the client must enter in manually to establish the connection oriented session. However, this is tedious and error prone. If the information that the client enters does not exactly match the information that the server sent, the server may refuse to establish the connection oriented session or may establish the session but fail to realize that the client establishing the connection oriented session is the same client that contacted the server at first. Thus, the server may refuse to grant the client the access and privilege to which the client is entitled. For example, the server expect the client to re-enter a password when using the second communication link to gain full access to a network that the server controls.

Therefore, a need exists for a method allowing a node to establish a connection oriented session by a convenient path, when the node does not have software to establish the connection oriented connection directly. A further need exists for such a method that reduces the chance of errors occurring in the process and that increases the chance that the client will have the full accesses and privileges deserved with respect to the second connection.

### DISCLOSURE OF THE INVENTION

Accordingly, embodiments of the present invention provide a method of establishing a logical association between different connections made between two nodes. Embodiments of the present invention provide for such a method that reduces the chance of errors occurring in the process and that increases the chance that the client will have the full accesses and privileges to which the client is entitled with respect to the second connection. These and other advantages of the present invention will become apparent within discussions of the present invention herein.

A method of establishing a logical association between connections is disclosed. A method embodiment generates a datum at a first node in response to a request from a second node. The datum is sent to the second node via a first connection. An application program is also sent to the second node. The application program is for the second node to interface with the first node to establish the second connection and to assist in associating the first connection with the second connection. A command is received by the first node from the second node via a second connection. The command includes the datum. A logical association is then established between the first connection and the second connection in response to receiving the command.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 illustrates a diagram illustrating nodes have connections that are logically associated, in accordance with embodiments of the present invention.

FIG. 2A illustrates a flowchart showing steps of a process of nodes exchanging commands to establish a logical association between multiple connections, in accordance with embodiments of the present invention.

FIG. 2B illustrates a flowchart showing steps of a process of nodes exchanging commands to establish a logical association between multiple connections, in accordance with embodiments of the present invention.

FIG. 3 illustrates a flowchart showing steps of a process of nodes exchanging commands to establish a logical association between multiple connections, in accordance with embodiments of the present invention.

FIG. 4 is a table illustrating commands defined in embodiments of the present invention to establish a logical association between connections.

FIG. 5A is a diagram illustrating a node having multiple connections logically associated with a first connection, in accordance with embodiments of the present invention.

FIG. 5B is a diagram illustrating a node having multiple connections having logical associations with a first connection, in accordance with embodiments of the present invention.

FIG. 5C is a diagram illustrating multiple nodes with their connections logically associated, in accordance with embodiments of the present invention.

FIG. 6 illustrates steps of a process of a node establishing a logical association between multiple connections made to it, in accordance with embodiments of the present invention.

### BEST MODE FOR CARRYING OUT THE INVENTION

In the following detailed description of the present invention, numerous specific details are set forth in order to provide a thorough understanding of the present invention. However, it will be obvious to one skilled in the art that the present invention may be practiced without these specific details or by using alternate elements or methods. In other instances well known methods, procedures, components, and circuits have not been described in detail as not to unnecessarily obscure aspects of the present invention.

Embodiments of the present invention allow a logical association to be made between connections that two or more nodes have between them. One of the connections may be connection oriented and the other connectionless, although this is not required. Embodiments allow a client that desires to have a connection oriented connection to contact a server via a connectionless protocol. The server assists in making the connection oriented connection without any manual client intervention, such as, for example, entering additional passwords, session identifiers, etc. Embodiments employ an exchange of Telnet options and/or Telnet sub-option commands between the nodes (e.g., client and server) to establish the logical association between the connections.

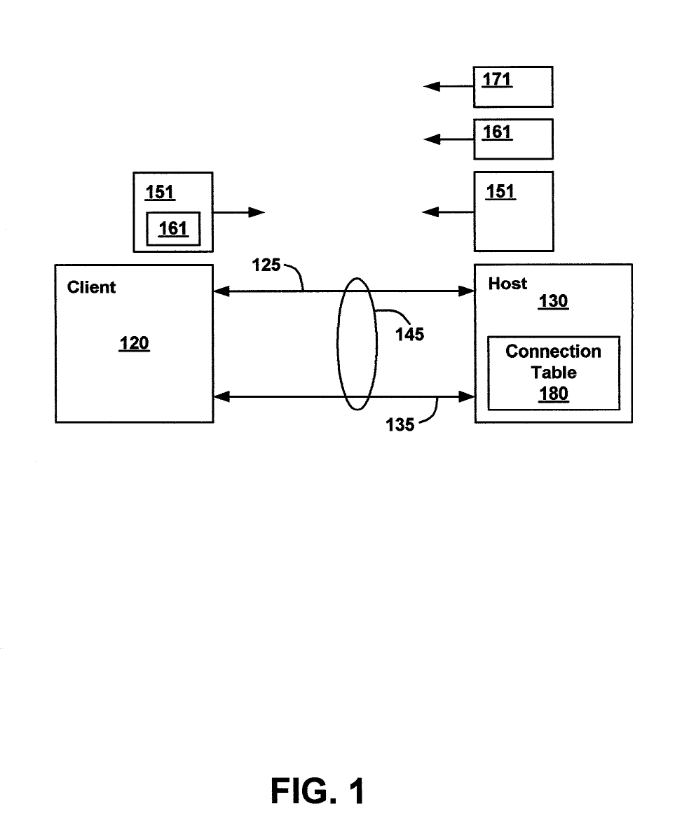

A diagram illustrating an example of making a logical association between connections is shown in FIG. 1. The diagram shows two connections that are logically associated and information that is exchanged to establish the logical association. A client node 120 and a host or server node 130 have a first connection 125 between them. Throughout this application, the nodes which share the connections may be referred to as a first node and a second node. The nodes shown in FIG. 1 are exemplary. The first and second nodes may be any two nodes. This first connection 125 may be established by any suitable method, for example, it may be a LAN (Local Area Network), WLAN (Wireless LAN), serial port, modem, etc. The server node 130 sends a datum 161 to the client node 120, which the client node 120 sends back to associate the second connection 135 with the first connection 125.

Referring further to FIG. 1, Telnet commands 151 (e.g., Telnet option, Telnet sub-option commands or the like) are exchanged between the client node 120 and the server node 130. The commands 151 define the actions to be taken at the nodes and, in one embodiment, instruct the server node 130 to logically associate the second connection 135 with the first connection 125 if the client node 120 includes the datum 161 in the exchange. The second connection 135 may be established by any suitable method, for example, it may be a LAN (Local Area Network), WLAN (Wireless LAN), serial port, modem, etc. The exchange of Telnet commands 151 happens automatically, without the client 120 needing to manually enter data to associate the two connections. For example, the server 130 may send the client an applet 171 to automatically perform the exchange of commands 151. Thus, information that the client 120 has already entered, that the server 130 has already generated, or is associated with the first connection 125 in another fashion may be associated with the second connection 135. For example, the server 130 stores a connection table 180 containing connection specific information. This allows the server 130 to associate information from the first connection 125 with the second connection 135.

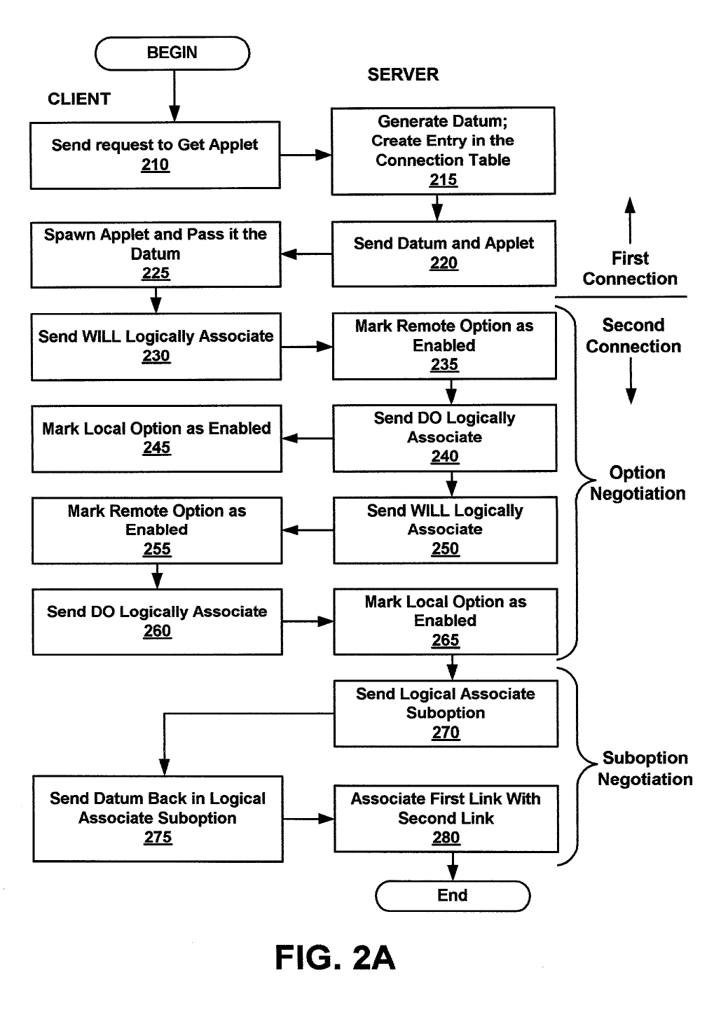

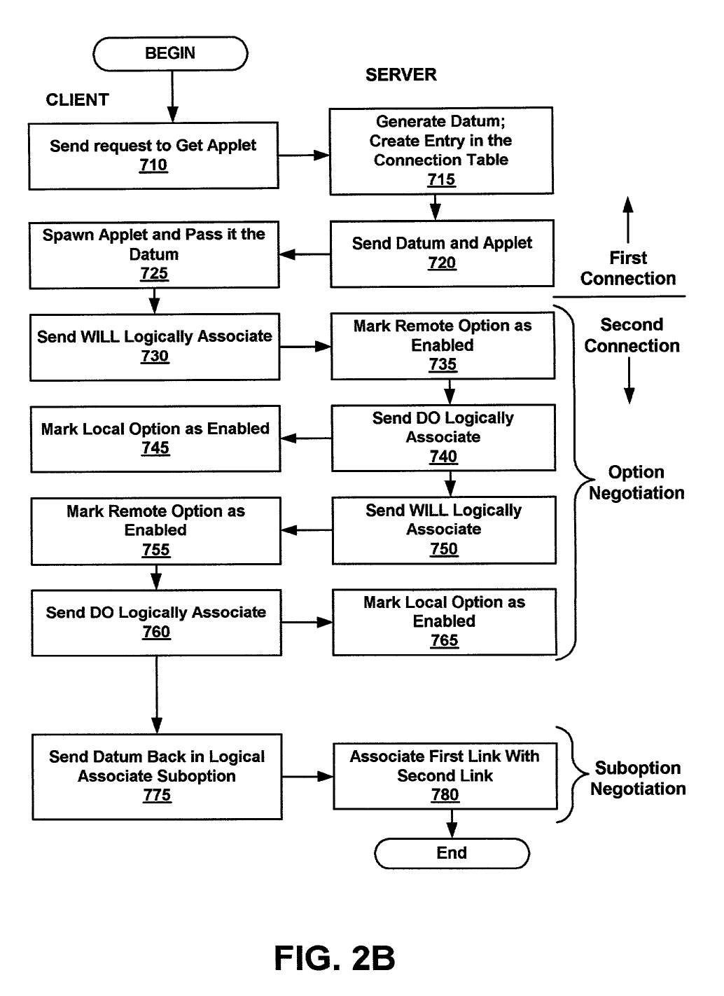

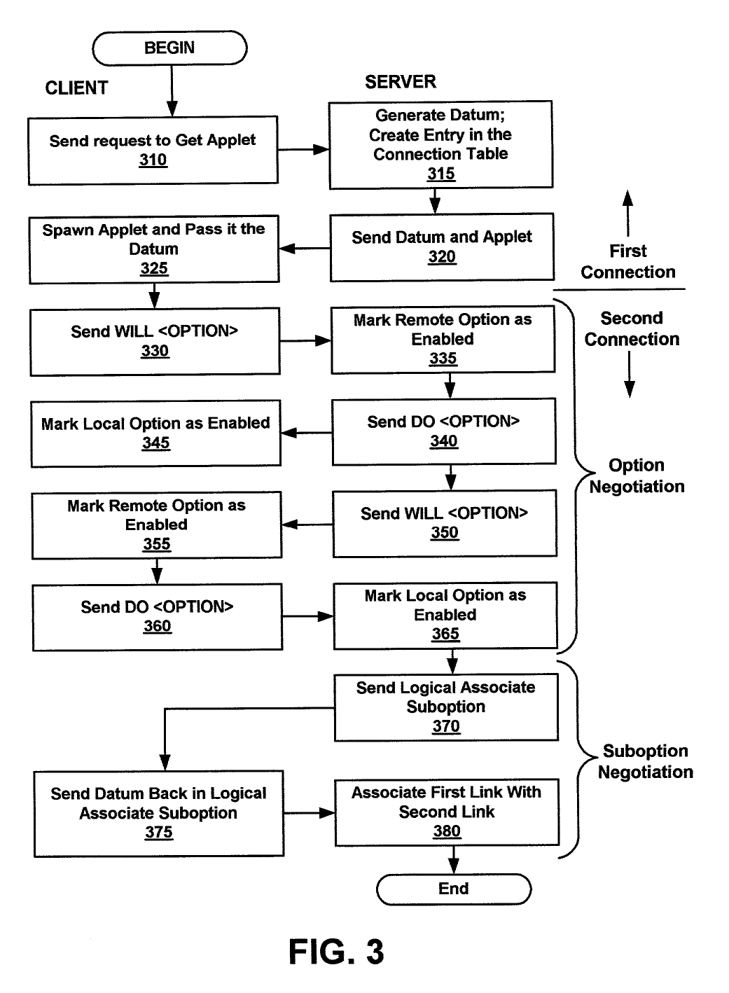

In one embodiment of the present invention, nodes exchange a specially designed Telnet sub-option command or negotiation that allows a logical association 145 to be made between two or more connections. Throughout this application, the sub-option command or negotiation may be referred to as a logical association sub-option negotiation. The logical association suboption may be a part of any Telnet option negotiation. For example, in one embodiment the Telnet logical association sub-option negotiation is preceded by a Telnet logical association option negotiation, as seen in FIG. 2A. In another embodiment, any suitable and allowable Telnet option negotiation may precede the logical association suboption negotiation, as seen in FIG. 3.

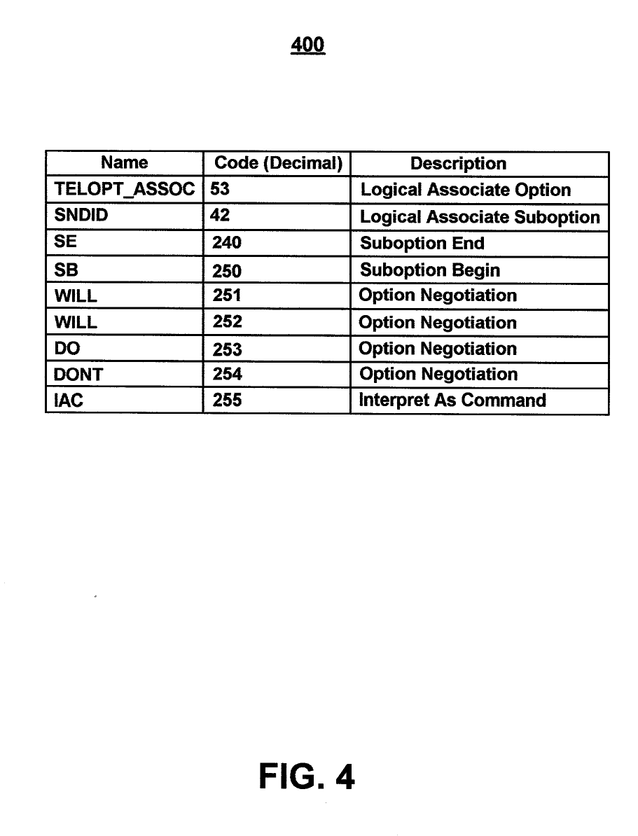

Referring to table 400 in FIG. 4, an embodiment defines a Telnet option with the arbitrary name ‘TELOPT_ASSOC’ whose exemplary value is decimal 38. Embodiments of the present invention may use other names and values, so long as they are unused by other Telnet options or the like. The Telnet option ‘TELOPT_ASSOC’ may be used with the Telnet WILL and DO requests to negotiate whether the nodes will support the option of logically associating two or more connections (e.g., it may be used during an option negotiation).

Still referring to FIG. 4, an embodiment defines a Telnet suboption with the arbitrary name ‘SNDID,’ whose exemplary value is decimal 42. The present invention may use other names and values, so long as they are unused by other Telnet options, suboptions, or the like. The Telnet suboption ‘SNDID’ may be used to negotiate the transfer of the datum 161 that is used to identify the first connection 125 (e.g., it may be used during a suboption negotiation). Thus, it allows the first connection 125 to be logically associated with the connection being used to transfer the Telnet suboption (e.g., second connection 135).

Referring now again to the flowchart of FIG. 2A and to the table of FIG. 4, first the client node 120 initiates the establishment of a first connection 125 to the server node 130, in step 210. For example, the client node 120 sends an ‘HTTP Get index.html’ to the server node 130. However, the present invention is not limited to establishing the first connection via HTTP, for example, the first connection 125 may be via SNMP (Simple Network Management Protocol), or any other connection method. The client node 120 also indicates to the server 130 that it desires to establish a second connection 135, for example, a connection oriented connection.

In step 215, when the server node 130 receives the request, the server node 130 generates a datum 161, which may be used to link the first connection 125 to the second connection 135. For example, the datum 161 may be a session identifier, a connection identifier, or any other identifier to allow the server 130 to recognize, when communicating with a node via a second connection 135, that the node sending it is the node that had the first connection 125. The server node 130 may store the datum 161 in a connection table 180, which also includes connection specific items.

In step 220, the server node 130 sends the datum 161 and an applet 171 to the client node 130. The applet 171 may be used to establish the second connection 135 and may also be used by the client node 120 to walk through the exchange of commands 151 with the server node 130 to establish the logical association 145 between the connections (125, 135). Additionally, the server node 130 may send contextual information such as, for example, user access level, encryption keys, security levels, etc.

In step 225, when the client 130 receives the applet 171, the applet 171 is spawned and passed the datum 161. The applet 171 then attempts to establish a second connection 135 to the server 130. In the present embodiment, the client node 120 and the server node 130 first engage in a specially defined Telnet option negotiation to establish that both nodes wish to support the logical association option. Then, the two nodes engage in a specially defined Telnet suboption negotiation to cause the logical association between the connections to be established.

Thus, after the second connection 135 is established, in step 230, the client node 120 sends a ‘WILL logically associate’ request to indicate that the client node 120 wants to enable the logical association option. The client 120 may send the string ‘WILL TELOPT_ASSOC’ to accomplish this. Referring to the Table of FIG. 4, this may have the hexadecimal value of ‘ff fb 35’. As stated herein, the value of the TELOPT_ASSOC option may be any unused value in the Telnet protocol. Throughout this application the entire string just described and similar strings may be defined as a Telnet command.

In step 235, when the server node 130 receives the request, it marks the remote option as enabled. Then, in step 240, the server node 130 sends a ‘DO logically associate’ to indicate that the client 120 may enable the option for logical association. The server 130 may send the string ‘IAC DO TELOPT_ASSOC’ to accomplish this. Referring to the Table of FIG. 4, the hexadecimal values for this string may be ‘ff fd 35’. Again, the TELOPT_ASSOC value of 35 hexadecimal is exemplary.

In step 245, in response to the ‘DO request’ from the server 130, the client node 120 marks the local option as enabled.

Next in step 250, the server 130 sends a ‘WILL logically associate’ request to indicate it wants to enable the option for logical association on its side. The server 120 may send the string, ‘IAC WILL TELOPT_ASSOC’ to accomplish this. The hexadecimal values for this string may be ‘ff fb 35’. Again, the TELOPT_ASSOC value of 35 hexadecimal is exemplary.

In response to the ‘WILL request,’ the client 120 marks the remote option as enabled, in step 255. Then, the client 120 sends a ‘DO logically associate’ request to indicate that the server 130 may enable the option for logical association on the server 130, in step 260. The client 120 may send the string ‘IAC DO TELOPT_ASSOC’ to accomplish this. The hexadecimal values for this string may be ‘ff fd 35’. Again, the TELOPT_ASSOC value of 35 hexadecimal is exemplary.

Upon receiving the ‘DO request,’ the server 130 marks the local option as enabled, in step 265. At this point a second connection 135 has been opened, but it is not yet associated with the first connection 125. To achieve this, suboption commands are exchanged in a suboption negotiation.

In step 270, the server 130 sends a logical association option with a logical association suboption. For example, it sends the string, ‘IAC SB TELOPT_ASSOC SNDID IAC SE’, which may have the hexadecimal value of ‘ff fa 35 2a ff f0.’ This instructs the client 120 to send back the datum 161 if it wants to logically associate the two connections. Throughout this application the entire string just described and similar strings may be defined as a Telnet command.

Then, in step 275, the client 120 sends back the logical association option and suboption, along with the datum 161. For example, it may send the string, ‘IAC SB TELOPT_ASSOC SNDID DATUM IAC SE’. This may have the hexadecimal value of ‘ff fa 35 2a 2f <DATUM> ff f0.’

In step 280, the server 130 may take a series of actions. First, the server 130 verifies that the datum 161 is valid. For example, it verifies that the datum 161 is in the connection table 180. It may thus associate the first connection 125 (e.g., an http connection) with the second connection 135 (e.g., a Telnet connection). Furthermore, the server 130 may associate connection specific items that are in the connection table 180 with the second connection 135. At this point the exchange of commands is complete.

The present invention is not limited to the server 130 sending a logical associate suboption as in step 270. FIG. 2B illustrates steps of a Process in which only a single Telnet command is required as a part of the suboption negotiation. Steps 710-765 are similar to steps 210-265 and the description associated with FIG. 2A may be referred to for details regarding these steps.

After step 260, in which the client node 120 sends the DO Logically associate command, the client node 120 sends the datum 161 to the server 130 in a Telnet logical associate suboption, in step 775. However, in this case, the client 120 does not wait for the server 130 to send a send logical associate suboption. Thus, the suboption negotiation stage may be stated to requiring only a single Telnet command.

In step 780, when the server 130 receives the command, the server 130 may take a series of actions. First, the server 130 verifies that the datum 161 is valid. For example, it verifies that the datum 161 is in the connection table 180. It may thus associate the first connection 125 (e.g., an http connection) with the second connection 135 (e.g., a Telnet connection). Furthermore, the server 130 may associate connection specific items that are in the connection table 180 with the second connection 135. At this point the exchange of commands is complete.

The present invention is not limited to preceding the logical association suboption negotiation with a logical association option negotiation. In another embodiment, the logical association suboption negotiation may be coupled with any suitable Telnet option negotiation. Referring now to FIG. 3, this embodiment differs from the embodiment of FIG. 2A in that the option which follows all of the WILL and DO requests may be any suitable and permissible option. For example, to perform the option negotiation, the string may be ‘IAC WILL <OPTION_NAME>.’

Referring to FIG. 3, steps 310-320 are essentially the same as the analogous steps in FIG. 2A. In steps 330-365, the client 120 and server 130 perform an option negotiation in which they exchange WILL and DO commands in a similar fashion as described in the embodiment of FIG. 2A.

Still referring to FIG. 3, after negotiating the option (e.g., exchanging WILL and DO), the nodes engage in suboption negotiation in a similar fashion to the embodiment shown in FIG. 2A. For example, in step 370 to send the suboption, the server 130 may send the string ‘IAC SB<OPTION_NAME> SNDID IAC SE.’ The client 120 may respond by sending the string ‘IAC SB<OPTION_NAME> SNDID <DATUM> IAC SE’, in step 375. The exchange of commands in FIG. 3 then ends. The process completes by the server 130 associating the first connection 125 with the second connection 135, in step 380.

FIG. 3 may be modified by skipping step 370, in a similar fashion to the embodiment illustrated in FIG. 2B. Thus, this embodiment only requires a single Telnet command to establish the association between the two communication links, although other Telnet commands may be used for other purposes.

The present invention is not limited to the logical association 145 being between only two connections. Furthermore the present invention is not limited to the logical association 145 between connections involving only two nodes. Rather, embodiments of the present invention may establish a logical association 145 between a group of connections. Embodiments may establish multiple logical associations 145 between a group of connections and a single connection. Furthermore, embodiments form a logical association between connections involving multiple nodes.

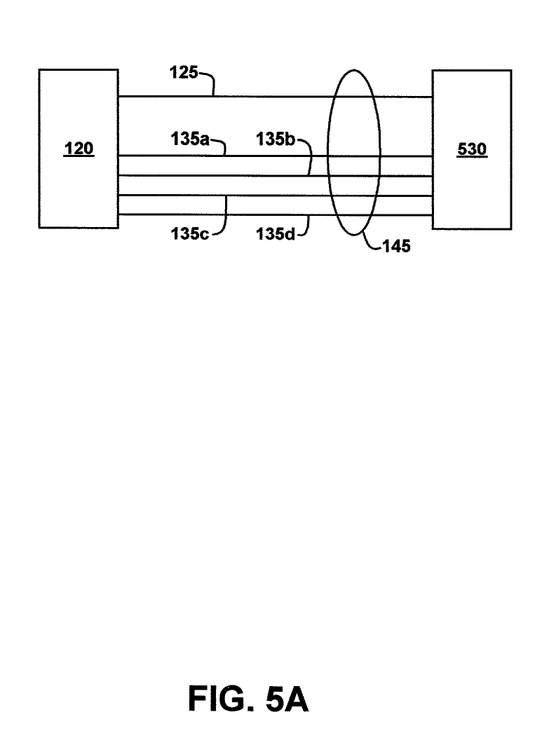

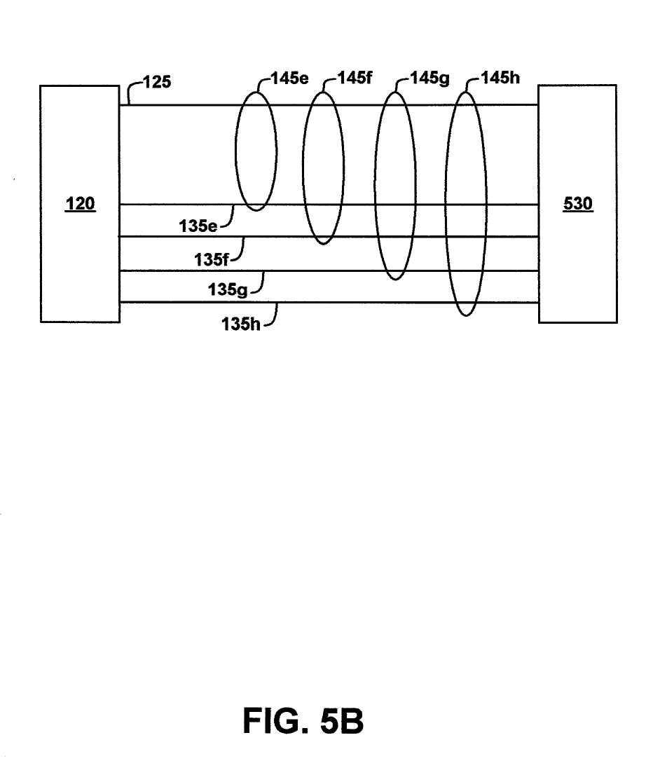

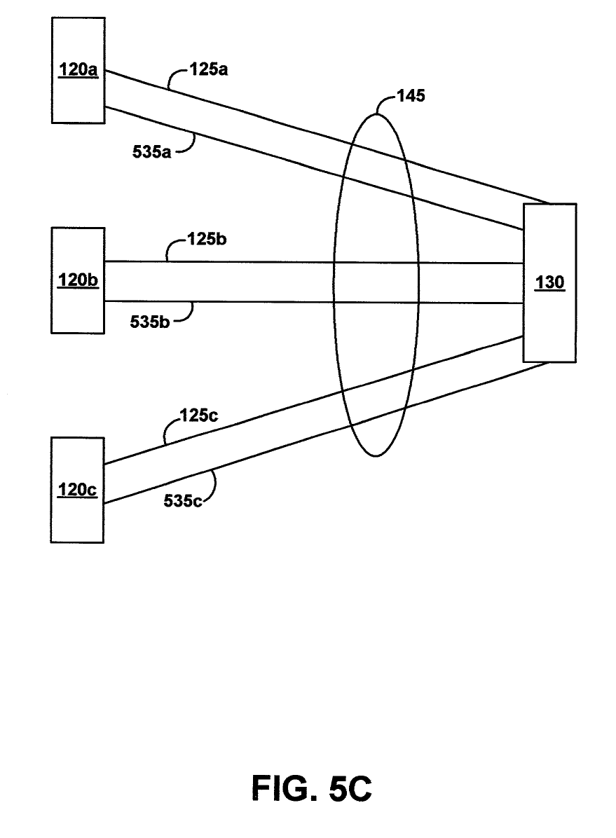

For example, referring to FIG. 5A, a client node 120 has a single first connection 125 and multiple second connections 135a-135d to a node 530. For example, the client 120 may be connecting to a switch 530 with a Telnet interface. The client 120 makes a first connection 125 to the switch 530. If the client 120 wishes to examine another aspect of the switch's operation, the client 120 may need another connection to the switch 530. However, the client 120 does not wish to drop the first connection 125 or to have to re-enter passwords, etc. to establish the second connection 135. An embodiment of the present invention allows the client 120 to spawn another version of the applet 171 and to establish another connection 135 to the switch 530 without any manual intervention. Because the applet 171 sends the datum 171, the switch 530 will recognize that it already has a first connection 125 to the client 120 and will not force the client 120 to drop its first connection 125 or to re-enter passwords, etc. Moreover, the client node 120 may establish multiple additional (second) connections 135a-135d and logically associate these with the first connection 125.

Still referring to FIG. 5A, the logical association 145 is shown between the first connection 125 and multiple second connections 135a-135d. This logical association 145 may be established by the client 120 passing the same datum 161 (e.g., session ID) each time a new connection is established. FIG. 5B shows an embodiment in which there is a logical association 145e-145h between each additional connection 135e-135h and the first connection 125.

Referring now to FIG. 5C, an embodiment of the present invention logically associates connections involving multiple nodes (e.g., multiple client nodes 120). For example, client nodes 120a-120c may be engaged in a game in which each client node 120-120c has established a first connection 125a-125c (e.g., an http connection) to the server 130. Additionally, each client node 120 has established a second connection 535a-535c (e.g., a Telnet connection) to the server 130. The embodiment of FIG. 5C shows a logical association 145 between the connections of multiple client nodes 120.

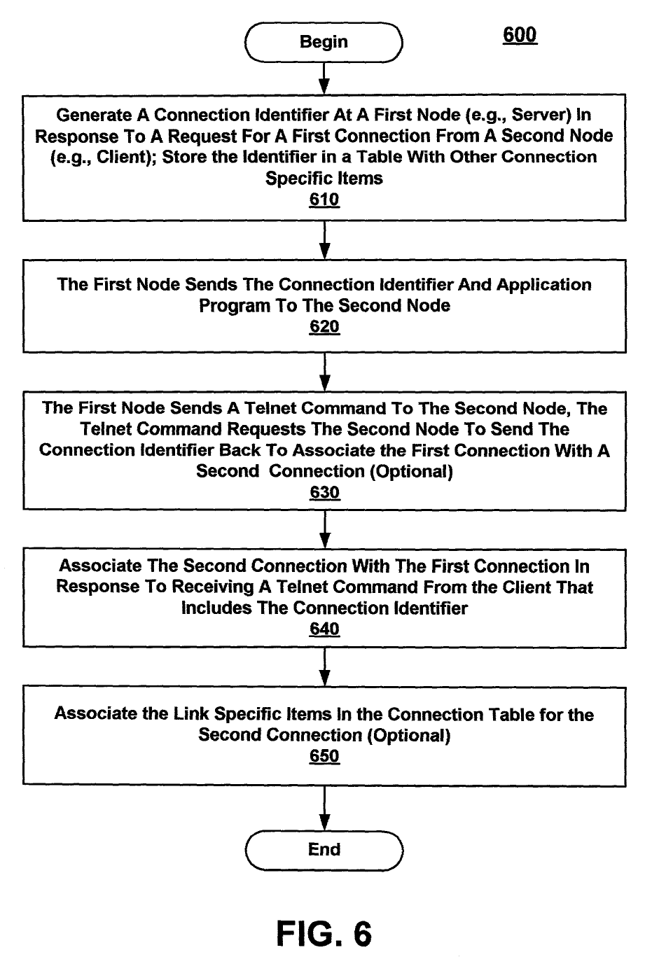

One embodiment of the present invention provides a method of establishing a logical association 145 between a first connection 125 and a second connection 135. Steps of Process 600 of FIG. 6 may be implemented by executing instructions on a general purpose processor or computer, which may be coupled to a computer-readable medium that stores the instructions. For example, the server 130 may execute steps of Process 600.

In step 610, a first node (e.g., server 130) generates and stores a connection identifier (e.g., datum 161) in response to a request received via a first connection 125 from a second node (e.g., a client node 120). The request may be initiated, for example, when the client 120 wishes to obtain an applet 171 to establish a connection oriented connection and to logically associate the connection oriented connection with the connection used to retrieve the applet 171. Along, with the datum 161, connection specific items may also be stored in a connection table 180.

In step 620, the server 130 sends the connection identifier over a first connection (e.g., the connection used to retrieve the applet 171) to the client 120. In this step, the server 130 may also send application program (e.g., the applet 171) to the client node 120 to allow the client node 120 to interface with the server 130 to associate the first connection 125 with a second connection 135 that will be established later.

In step 630, after the second connection 135 has been established, the server 130 sends a first Telnet command 151 via the second connection 135 to the client 120. The first Telnet command 151 requests the client 120 to send the connection identifier back to associate the first connection 125 with the second connection 135. It will be understood that there may be additional Telnet commands before the first Telnet command. Furthermore, embodiments of the present invention skip this step.

Then, in step 640, in response to receiving a Telnet command 151 from the client 120 that includes the connection identifier, the server 130 establishes a logical association 145 between the first connection 125 and the second connection 135.

In optional step 650, the server 130 associates the link specific items in the connection table 180 with the second connection 135. Process 600 then ends. Process 600 may be expended to cover cases, such as, for example shown in FIGS. 5A-5C, in which multiple nodes and connections are involved.

While the present invention has been described in particular embodiments, it should be appreciated that the present invention should not be construed as limited by such embodiments, but rather construed according to the below claims.

What is claimed is:

1. A method of establishing a logical association between connections, said method comprising:
a) generating a datum at a first node in response to a request from a second node;
b) sending said datum to said second node via a first connection;
c) sending an application program to said second node, said application program for said second node to interface with said first node to establish a second connection and to assist in associating said first connection with said second connection;
d) receiving a command at said first node from said second node via a second connection, said command including said datum; and
e) establishing a logical association between said first connection and said second connection in response to receiving said command.

2. The method of claim 1, wherein said first connection is a connectionless connection and said second connection is a connection oriented connection.

3. The method of claim 2, wherein said command is a Telnet command.

4. The method of claim 3, further comprising sending a second Telnet command to said second node requesting said second node to send said datum back to logically associate said first connection with said second connection.

5. The method of claim 4, wherein said Telnet commands are Telnet suboption commands, wherein said first node and said second node engage in a Telnet suboption negotiation.

6. The method of claim 4, further comprising:
f) sending a third Telnet command to said second node via a third connection, said third Telnet command requesting said second node to send said datum back to associate said first connection with said third connection; and
g) establishing said logical association to further include said third connection in response to receiving a fourth Telnet command that includes said datum, said fourth Telnet command being received from said second node.

7. The method of claim 4, further comprising:
f) sending a third Telnet command to said second node via a third connection, said third Telnet command requesting said second node to send said datum back to associate said first connection with said third connection; and
g) establishing a second logical association, said second logical association being between said first connection and said third connection, said establishment in response to receiving a fourth Telnet command that includes said datum, said fourth Telnet command being received from said second node.

8. The method of claim 1, wherein:
a) comprises generating a plurality of datums at said first node in response to requests from a plurality of nodes;
b) comprises sending said plurality of datums to said plurality of nodes via a plurality of first connections;
c) comprises sending a plurality of application programs to said plurality of nodes;
d) comprises receiving a plurality of commands at said first node from said plurality of nodes via a plurality of second connections, said commands including said plurality of datums; and
e) establishing said logical association between said plurality of first connections and said plurality of second connections in response to receiving said plurality of commands.

9. The method of claim 1, wherein:
a) further comprises storing said datum and connection specific items for said first connection and associating said datum with said items; and
d) further comprises associating said items with said second connection.

10. A computer readable medium having stored thereon instructions, which when run on a processor execute a method of establishing a logical association between connections, said method comprising:
a) generating and storing a connection identifier at a first node in response to a request received via a first connection from a second node;
b) sending said connection identifier over said first connection to said second node;
c) sending an application program to said second node, said application program for performing a negotiation to associate said first connection with a second connection; and
d) establishing a logical association between said first connection and a second connection in response to receiving a Telnet command at said first node, said received Telnet command including said connection identifier.

11. The computer readable medium of claim 10, wherein said method further comprises sending a Telnet command via said second connection to said second node, said sent Telnet command requesting said second node to send said connection identifier in said received Telnet command.

12. The computer readable medium of claim 10, wherein said sent and received Telnet commands are Telnet suboption commands.

13. The computer readable medium of claim 10, wherein:
a) of said method further comprises storing said connection identifier and connection specific items for said first connection in a table and linking said items with said connection identifier; and
d) of said method further comprises associating with said second connection said items in said table that are linked with said connection identifier.

14. The computer readable medium of claim 10, wherein said method further comprises:
e) sending a third Telnet command via a third connection to said second node, said third Telnet command requesting said second node to send said connection identifier back to associate said first connection with said third connection; and
f) establishing said logical association to further include said third connection in response to receiving a fourth Telnet command that includes said connection identifier.

15. The computer readable medium of claim 10, wherein said method further comprises:
e) sending a third Telnet command to said second node via a third connection, said third Telnet command requesting said second node to send said connection identifier back to associate said first connection with said third connection; and
f) establishing a second logical association, said second logical association linking said first connection with said third connection, said establishment in response to receiving a fourth Telnet command that includes said connection identifier.

16. The computer readable medium of claim 10, wherein:
a) of said method comprises generating and storing a plurality of connection identifiers at said first node in response to requests from a plurality of nodes;
b) of said method comprises sending said plurality of connection identifiers to said plurality of nodes via a plurality of first connections;
c) of said method comprises sending a plurality application programs to said plurality of nodes; and
d) of said method comprises establishing said logical association between said plurality of first connections and said plurality of second connections in response to receiving a plurality of second Telnet commands that include said plurality of connection identifiers.

17. A method of establishing a logical association between connections, said method comprising:
a) establishing a first connection between a first node and a second node;
b) said second node generating and storing an identifier at said first node;
c) said second node sending said identifier to said first node;
d) said first node and said second node performing a Telnet suboption negotiation to establish said logical association between said first connection and a second connection, said suboption negotiation taking place via said second connection, said suboption negotiation comprising:
d1) said second node sending a Telnet suboption command to said first node indicating said first node should return said identifier to associate said first connection with said second connection;
d2) said first node sending said identifier to said second node in a Telnet suboption command; and
e) said second node associating said first connection with said second connection.

18. The method of claim 17 wherein e) comprises said second node verifying that said identifier is a stored identifier.

19. The method of claim 17, wherein c) further comprises:
sending an application program to said first node, said application program for said first node to interface with said second node to establish said second connection.

20. The method of claim 17, wherein c) further comprises sending an application program to said first node, said application program for performing said suboption negotiation.
